(19) United States
(12) Patent Application Publication
(10) Pub. No.: US 2013/0134847 A1
(43) Pub. Date: May 30, 2013

(54) HOUSEHOLD APPLIANCE INCLUDING FORCE DISTRIBUTOR

(71) Applicants: Louis Kinlaw, Greenville, NC (US); Rob Ladner, Dryden, MI (US)

(72) Inventors: Louis Kinlaw, Greenville, NC (US); Rob Ladner, Dryden, MI (US)

(73) Assignee: BSH HOME APPLIANCES CORPORATION, Huntington Beach, CA (US)

(21) Appl. No.: 13/305,781

(22) Filed: Nov. 29, 2011

(51) Int. Cl. A47B 97/00; A47B 96/00; B23P 17/04

(52) U.S. Cl. 312/237; 29/428

(57) ABSTRACT

A household appliance including a cabinet having a frame and one or more force distributors structured to absorb forces that the cabinet receives during shipping and handling. The one or more force distributors may include a block portion having cut-out sections throughout that lead to a generally flat planar bottom portion. To reduce material costs, the cut-out sections may include a surface area of greater than fifty percent of the total surface area of the one or more force distributors. The invention also includes a method for attaching the one or more force distributors to the household appliance.

### BACKGROUND OF THE INVENTION

1. Field of the Invention

The present invention relates to a household appliance and more particularly, to a household appliance including one or more force distributors and a method thereof that is used to absorb forces during shipping and handling of the dishwasher.

2. Related Art

In the related art, household appliances, such as dishwashers, include mechanisms such as packaging and force distributors that are used to protect the household appliance during shipping and handling. However, in the related art, the force distributors often require the use of screws to attach them to the dishwasher. Further, the force distributors are often costly to produce, in part due to material costs.

The present invention introduces a household appliance with one of more force distributors that use up to fifty percent less material than related art force distributors and also eliminate the need for attachment screws. In exemplary embodiments of the invention, the force distributors use snap-fit mechanisms as well as press-fit mechanisms to attach the force distributors to a frame of the dishwasher.

### SUMMARY OF THE INVENTION

A first aspect of the present invention is directed to a household appliance. The household appliance may include a cabinet having a frame and one or more force distributors structured to absorb forces that the cabinet receives during shipping and handling. The one or more force distributors may include a block portion having cut-out sections throughout that lead to a generally flat planar bottom portion. To reduce material costs, the cut-out sections may include a surface area of greater than fifty percent of the total surface area of the one or more force distributors.

A second aspect of the present invention is directed to a method for absorbing forces that a cabinet of a household appliance receives during shipping and handling. The method may include attaching one or more force distributors to a frame of the household appliance, the one or more force distributors including a block portion having cut-out sections throughout that lead to a generally flat planar bottom portion. Further, the one or more force distributors may be formed from injection molding.

The illustrative aspects of the present invention are designed to solve the problems herein described and other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various exemplary embodiments of the disclosure, in which:

FIG. 1 depicts a household appliance including a frame according to an exemplary embodiment of the invention;

FIG. 2 depicts a force distributor structured to absorb forces that a cabinet of the household appliance receives during shipping and handling;

FIG. 3 depicts a front portion of the frame including a cut-out section to which the force distributor is attached according to an exemplary embodiment of the invention;

FIG. 4 depicts a second embodiment of a force distributor of the invention structured to absorb forces that the cabinet receives during shipping and handling;

FIG. 5 depicts a rear portion of the frame including a cut-out section to which the second embodiment of the force distributor is attached;

FIG. 6 depicts the force distributor of FIG. 2 formed in an approximate L-shape to attach to corners of the frame; and

FIG. 7 depicts an exemplary method of the invention for absorbing forces that a cabinet of a household appliance receives during shipping and handling.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

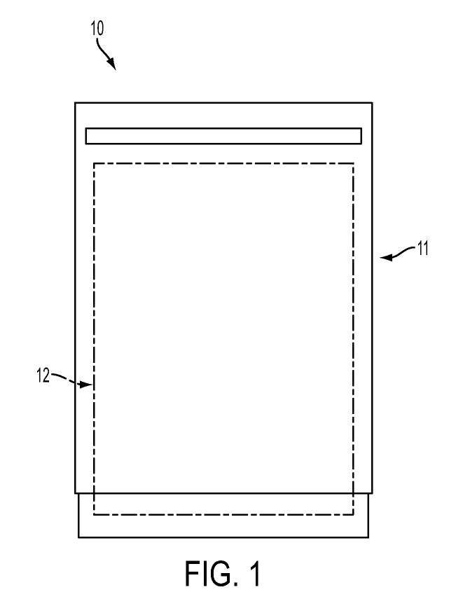

FIG. 1 shows an exemplary embodiment of a household appliance of the present invention, such as a dishwasher 10. The dishwasher 10 may comprise a door 11 which is suitable for tiltable opening. The dishwasher may further include a frame 12 to which the door is attached and which provides for structural integrity of the dishwasher 10.

While exemplary embodiments of force distributors are described below, it should be understood that the invention is not limited to these embodiments and it is envisioned that multiple configurations of the force distributors may be used that are formed by injection molding to include up to fifty percent less material and also eliminate the need for attachment screws, for example, by using snap-fit mechanisms as well as press-fit mechanisms to attach the force distributors to a frame of the dishwasher 1.

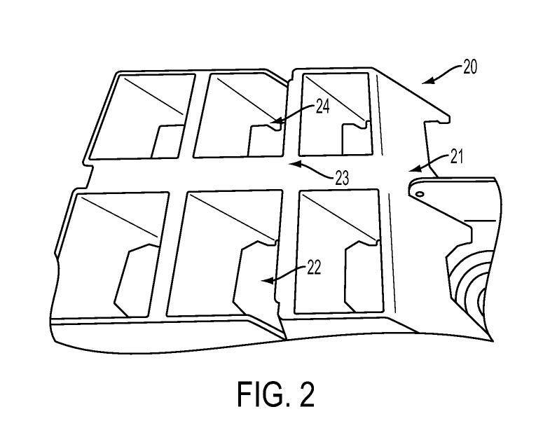

FIG. 2 depicts an exemplary embodiment of a force distributor 20 structured to absorb forces that the cabinet receives during shipping and handling. The force distributor 20 may be attached to the frame 12 and may include a block portion 21 having cut-out sections 22 throughout that lead to a generally flat planar bottom portion 23. In FIG. 2, the force distributor 20 may include a snap-fit mechanism 24, such as a hook mechanism to attach to the frame 12.

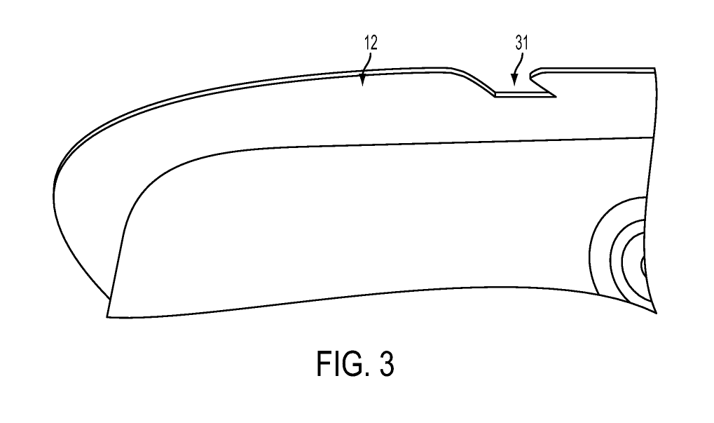

FIG. 3 depicts a front portion of the frame 12 including a cut-out section 31 to which the force distributor 20 is attached. In the embodiment of FIG. 3, the force distributor 20 may be attached at a front corner of the frame 12.

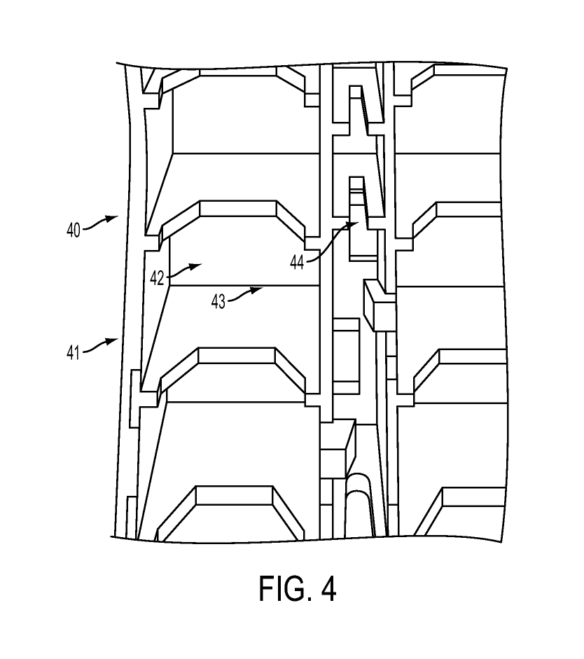

FIG. 4 depicts a second exemplary embodiment of a force distributor 40 structured to absorb forces that the cabinet receives during shipping and handling. Like force distributor 20, force distributor 40 may be attached to the frame 12 and include a block portion 41 having cut-out sections 42 throughout that lead to a generally flat planar bottom portion 43. In FIG. 4, the force distributor 40 may include a press-fit mechanism 44 to attach to the frame 12.

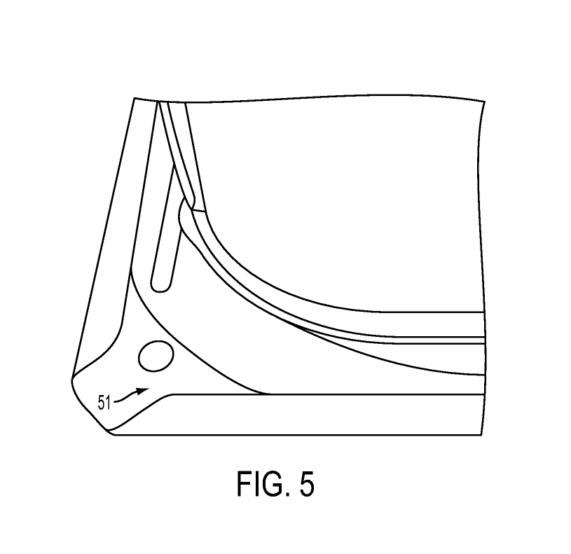

FIG. 5 depicts a portion of the frame 12 including a cut-out section 51 to which the force distributor 40 is attached. In the embodiment of FIG. 5, the force distributor 40 may be attached at a rear corner of the frame 12.

The force distributors 20, 40 may be formed by injection molding from a thermoplastic material known in the art such as at least one of polystyrene, polyethylene, polypropylene, nylon, high impact polystyrene and acrylonitrile butadiene styrene (ABS).

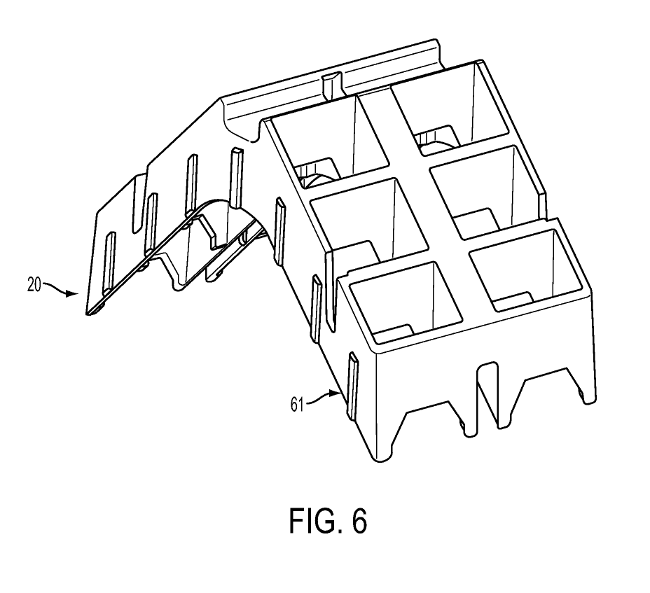

FIG. 6 depicts the force distributor 20 formed in an approximate L-shape to attach to corners of the frame 12. As shown in FIG. 6, the force distributor 20 may include ribs 61 on a side portion thereof to reinforce a stability of the force distributor 20.

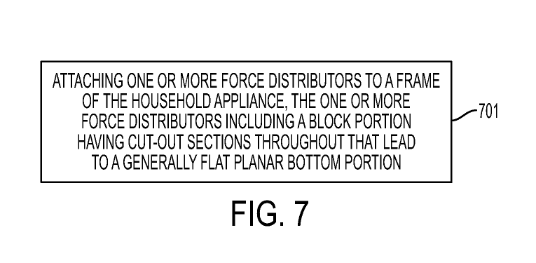

FIG. 7 depicts an exemplary method of the invention for absorbing forces that a cabinet of a household appliance receives during shipping and handling. The method includes at step 701, attaching one or more force distributors to a frame of the household appliance, the one or more force distributors including a block portion having cut-out sections throughout that lead to a generally flat planar bottom portion. In an exemplary method, the one or more force distributors may be formed from injection molding.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A household appliance, comprising:
a cabinet including a frame; and
one or more force distributors structured to absorb forces that the cabinet receives during shipping and handling, the one or more force distributors attaching to the frame and including a block portion having cut-out sections throughout that lead to a generally flat planar bottom portion, wherein the cut-out sections include a surface area of greater than fifty percent of the total surface area of the one or more force distributors.

2. The household appliance according to claim 1, wherein a first of the one or more force distributors include a snap-fit mechanism to attach to the frame.

3. The household appliance according to claim 2, wherein the snap-fit mechanism is a hook mechanism.

4. The household appliance according to claim 2, wherein the frame includes a cut-out section to which the first force distributor is attached.

5. The household appliance according to claim 2, wherein the first force distributor is attached at a front corner of the frame.

6. The household appliance according to claim 1, wherein a second of the one or more force distributors includes a press-fit mechanism to attach to the frame.

7. The household appliance according to claim 6, wherein the second force distributor is disposed at a rear corner of the frame.

8. The household appliance according to claim 6, wherein the frame includes a cut-out section to which the second force distributor is attached.

9. The household appliance according to claim 1, wherein the one or more force distributors is formed from a thermoplastic material

10. The household appliance according to claim 9, wherein the thermoplastic material is at least one of polystyrene, polyethylene, polypropylene, nylon, high impact polystyrene and acrylonitrile butadiene styrene (ABS).

11. The household appliance according to claim 1, wherein the cut-out sections are formed by injection molding.

12. (canceled)

13. The household appliance according to claim 1, wherein the one or more force distributors are formed in an approximate L-shape to attach to corners of the frame

14. The household appliance according to claim 1, wherein the one or more force distributors include ribs on a side portion thereof to reinforce a stability of the one or more force distributors.

15. A method for absorbing forces that a cabinet of a household appliance receives during shipping and handling, the method comprising the step of:
attaching one or more force distributors to a frame of the household appliance, the one or more force distributors including a block portion having cut-out sections throughout that lead to a generally flat planar bottom portion, wherein the cut-out sections are formed during injection molding to include a surface area of greater than fifty percent of the total surface area of the one or more force distributors.

16. The method for absorbing forces that a cabinet of a household appliance receives during shipping and handling according to claim 15, further comprising forming the one or more force distributors from injection molding.

17. (canceled)

18. The method for absorbing forces that a cabinet of a household appliance receives during shipping and handling according to claim 15, wherein a first of the one or more force distributors is snap-fit to attach to the frame.

19. The method for absorbing forces that a cabinet of a household appliance receives during shipping and handling according to claim 15, wherein a second of the one or more force distributors is press-fit to attach to the frame.

20. The method for absorbing forces that a cabinet of a household appliance receives during shipping and handling according to claim 15, wherein during injection molding, the one or more force distributors are molded to include ribs on a side portion thereof to reinforce a stability of the one or more force distributors.

21. The method for absorbing forces that a cabinet of a household appliance receives during shipping and handling according to claim 15, wherein the frame is formed to include a cut-out section to which the one or more force distributors are attached.
